(19) United States
(12) Patent Application Publication
(10) Pub. No.: US 2023/0190013 A1
(43) Pub. Date: Jun. 22, 2023

(54) SUPPORT FRAME

(71) Applicant: HUI-PEI HU, Taipei City (TW)

(72) Inventor: HUI-PEI HU, Taipei City (TW)

(21) Appl. No.: 17/680,338

(22) Filed: Feb. 25, 2022

(30) Foreign Application Priority Data
Dec. 22, 2021 (TW) 110148185

(51) Int. Cl. A47F 7/24; A47F 5/04; A47F 5/10; A47F 8/00; F16M 11/04; F16M 11/28; F16M 11/24

(52) U.S. Cl. CPC A47F 7/24; A47F 5/04; A47F 5/10; A47F 8/00; F16M 11/046; F16M 11/28; F16M 11/245; F16M 2200/066; F16M 2200/08

(57) ABSTRACT

A support frame disposed on a support surface comprises: a support member disposed on the support surface; a top block disposed on a top end of the support member; a first moving block having a first through hole, the support member penetrating through the first through hole; and two first flexible bands, overlapped to each other, two central portions of the two first flexible bands being positioned on the top block, two ends of each of the two first flexible bands being connected with the first moving block and set on two sides of the first through hole.

### BACKGROUND OF THE INVENTION

### 1. Field of the Invention

The present invention is in related to a support frame, more particularly to a support frame for hanging tactical equipment.

### 2. Description of the Prior Art

With reference to FIG. 1A and FIG. 1B, which illustrate a schematic view of a support frame 10 for tactical equipment in prior arts and a schematic view of the support frame 10 hanging a helmet 14 and a tactical vest 15 in prior arts. The support frame 10 includes a vertical support column 11, a horizontal support column 12 and a base 13, wherein the vertical support column 11, the horizontal support column 12 and the base 13 are made by plastic or metal material without elastic property. The horizontal support column 12 is divided into two sections that are a left horizontal column 12L and a right horizontal column 12R, and the vertical support column 11 is at the central of the horizontal support column 12.

The vertical support column 11 supports the helmet 14. That is, an upper end of the vertical support column 11 urges an inner surface of the helmet 14, but such arrangement could damage the inner surface. Further, the vertical support column 11 urging the helmet 14 is not a stable way, since the contact area of the vertical support column 11 urging the helmet 14 is very small, and it causes an unbalance situation. It is obvious that the helmet 14 may be easily fallen down once an outside force touches onto it.

Please refer to FIG. 1B again. The horizontal support column 12 is to hang the tactical vest 15. As shown in figure, the left horizontal column 12L and the right horizontal column 12R are formed as a straight line structure. Hence, the vertical support column 11 must pass through the neckline of the tactical vest 15 if the horizontal support column 12 hangs the tactical vest 15. In other words, the most volume of the vertical support column 11 is occupied by the tactical vest 15, so as to cause that the tactical vest 15 is not easily hung on the horizontal support column 12 or quickly removed from the horizontal support column 12. Besides, the support frame 10 is an integral structure or formed in a way of fastening, which means it is hardly folded to be carried on.

Consequently, how to improve the shortcomings as aforesaid becomes an important issue to the people skilled in the art.

### SUMMARY OF THE INVENTION

The main object of the present invention is to provide a support frame, which is capable of avoiding the damage of lining in helmet or hat and securely supporting helmet or hat. Therefore, helmet or hat is not fell down easily from the support frame. In addition, the support frame is easily folded to make the volume of the support frame be smaller, so as to approaches the target of user-friendly storage.

A support frame disposed on a support surface comprises: a support member disposed on the support surface; a top block disposed on a top end of the support member; a first moving block having a first through hole, the support member penetrating through the first through hole; and two first flexible bands, overlapped to each other, two central portions of the two first flexible bands being positioned on the top block, two ends of each of the two first flexible bands being connected with the first moving block and set on two sides of the first through hole.

Preferably, the support frame further comprises a second moving block, having a second through hole, the support member penetrating through the second through hole; and two first support arms, each of the two first support arms having a first assembly area, one end of the first support arm being pivotally connected with the second moving block, an angle between the two first support arms being obtuse.

Preferably, another end of the first assembly area is firmly positioned into the second through hole in a way of pin, an upper surface of the first support arm is inclined toward the support surface.

Preferably, the support frame further comprises a second support arm with a second assembly area, one end of the second assembly area being pivotally connected with the second moving block, another end of the second assembly area being firmly positioned into the second moving block in a way of pin, an angle between the second support arm and the first support arm being obtuse, wherein the second support arm and the first support arm are adjacent to each other.

Preferably, the first moving block has a first connecting portion and a first clamp ring, the two ends of the first flexible band are connected with the first connecting portion, the first clamp ring is disposed on the support member.

Preferably, the two ends of the first flexible band are detachably connected with the first moving blocks.

Preferably, the support member has an upper support member and a lower support tube, a bottom end of the upper support member is sleeved into the lower support tube, the upper support member is penetrated through the first through hole and the second through hole.

Preferably, the support frame further comprises: a second clamp ring, firmly disposed on the lower support tube; and two third support arms, each of the two third support arms having a third assembly area, one end of the third assembly area being pivotally connected with the second clamp ring (28), another end of the third assembly area being firmly disposed into the second clamp ring in a way of pin.

Preferably, the support frame further comprises: two auxiliary arms, each of the two auxiliary arms being corresponding to the third support arm and having a fourth assembly area; wherein one end of the fourth assembly area is pivotally connected with the corresponded third support arm, and another end of the fourth assembly area is firmly disposed into the corresponded third support arm in a way of pin.

Preferably, the support frame further comprises at least one second flexible band, the second clamp ring further having a rectangular slot; wherein two ends of the second flexible band are firmly embedded into the rectangular slot.

The present invention is with following advantages:

1. The damage of lining in helmet or hat is avoided, and helmet or hat is securely supported.
2. The effects of ventilation and dry is increasing.
3. The whole volume is smaller since the feature of easy folding, so as to be easily carried.
4. Tactical vest is quickly removed or attached.
5. Mechanisms for hanging tactical boots and water bags are fully equipped.
6. The drainage effect of tactical boots is improved and the prevention of foreign objects entering the shoes is reached.

The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A and FIG. 1B illustrate a schematic view of a support frame for tactical equipment in prior arts and a schematic view of the support frame hanging a helmet and a tactical vest in prior arts, respectively;

FIG. 2 illustrates a schematic 3-D view of an embodiment of a support frame 20 of the present invention;

FIG. 3 illustrates a schematic view of the support frame 20 set on a support surface 9 of the present invention;

FIG. 4 illustrates a schematic view of an upper support member 211 sleeved into a lower support tube 212 of the present invention;

FIG. 5A illustrates a schematic view of the top block 22, the upper support member 211, the first moving block 23, the two first flexible bands 24 of the present invention;

FIG. 5B illustrates a schematic view of the first moving block 23 of the present invention;

FIG. 5C illustrates a schematic view of one end of each of the two first flexible bands 24 departing from the first moving block 23 of the present invention;

FIG. 6A illustrates a schematic 3-D view of the second moving block 25, the two first support arms 26 and the second support arm 27 of the present invention;

FIG. 6B illustrates a schematic top view of the second moving block 25, the two first support arms 26 and the second support arm 27 of the present invention;

FIG. 6C illustrates a schematic view of the two first support arms 26 and the second support arm 27 in a folding state of the present invention;

FIG. 7A illustrates a schematic 3-D view of the second clamp ring 28, the two third support arms 29, the two auxiliary arms 291 of the present invention;

FIG. 7B illustrates a schematic 3-D view of the second clamp ring 28 of the present invention;

FIG. 7C illustrates a schematic view of a water bag 7 sleeved into the two second flexible bands 28B of the present invention;

FIG. 7D illustrates a schematic view of the two ends of only one the second flexible band 28B embedded into the rectangular slot 28G of the present invention;

FIG. 8 illustrates a schematic view of folding the two third supports arm 29 and the two auxiliary arms 291 of the present invention; and

FIG. 9 illustrates a schematic view of folding the support frame 20 of the present invention.

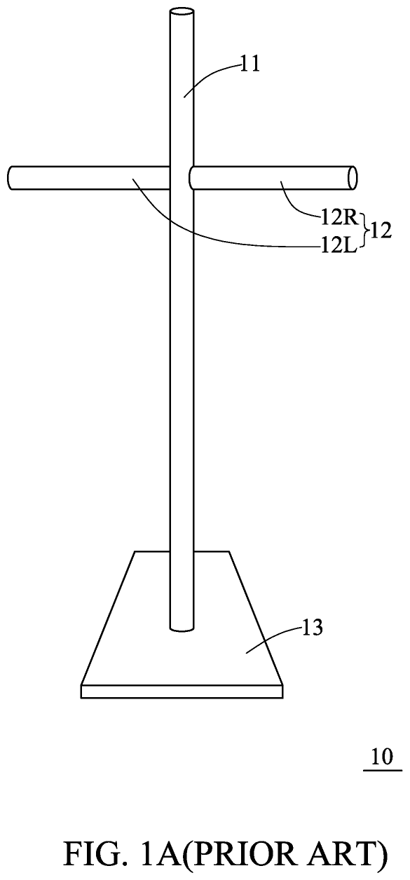

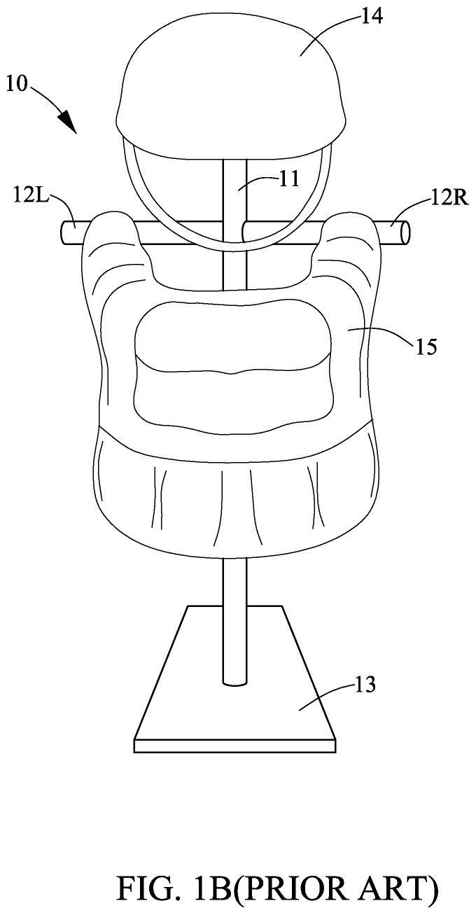

### DETAILED DESCRIPTION OF THE INVENTION

In order to describe in detail the technical content, structural features, achieved objectives and effects of the instant application, the following detailed descriptions are given in conjunction with the drawings and specific embodiments. It should be understood that these embodiments are only used to illustrate the application and not to limit the scope of the instant application.

All of the figures of the present invention are schematic views, and shown the relationships among the modules and signals, but the ratios of the circuits' dimensions, the signals' waveforms and the frequencies are not included.

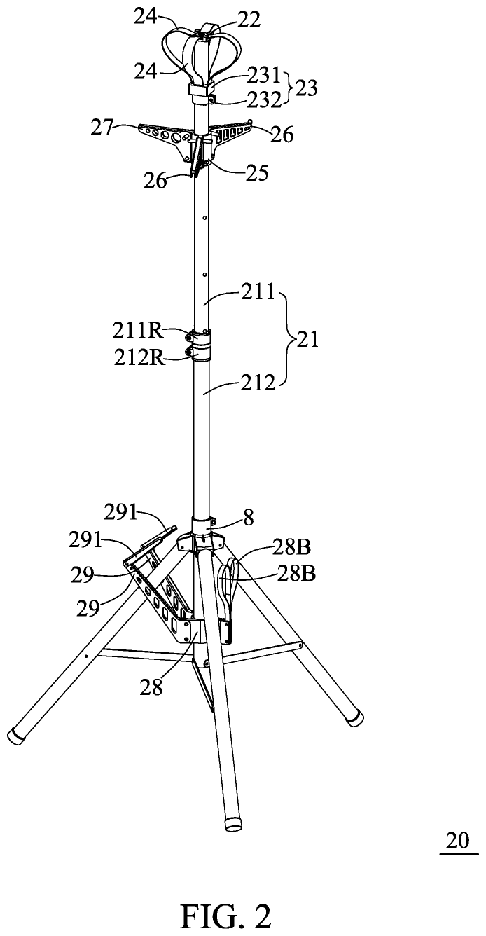

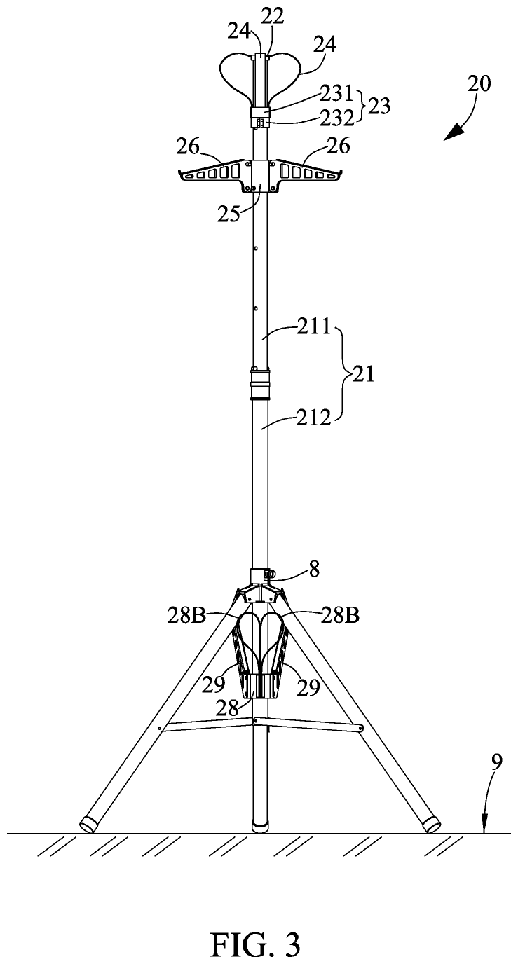

Please refer to FIG. 2 and FIG. 3, which illustrate a schematic 3-D view of an embodiment of a support frame 20 of the present invention and a schematic view of the support frame 20 set on a support surface 9 of the present invention. As it can be seen, the support frame 20 is adapted to be disposed on the support surface 9. The support frame 20 includes a support member 21, a top block 22, a first moving block 23, two first flexible bands 24 that are overlapped to each other, a second moving block 25, two first support arms 26, a second support arm 27, a second clamp ring 28, two third support arms 29, two auxiliary arms 291, two second flexible bands 28B, an upper clamp ring 211R, a lower clamp ring 212R, and a tripod 8.

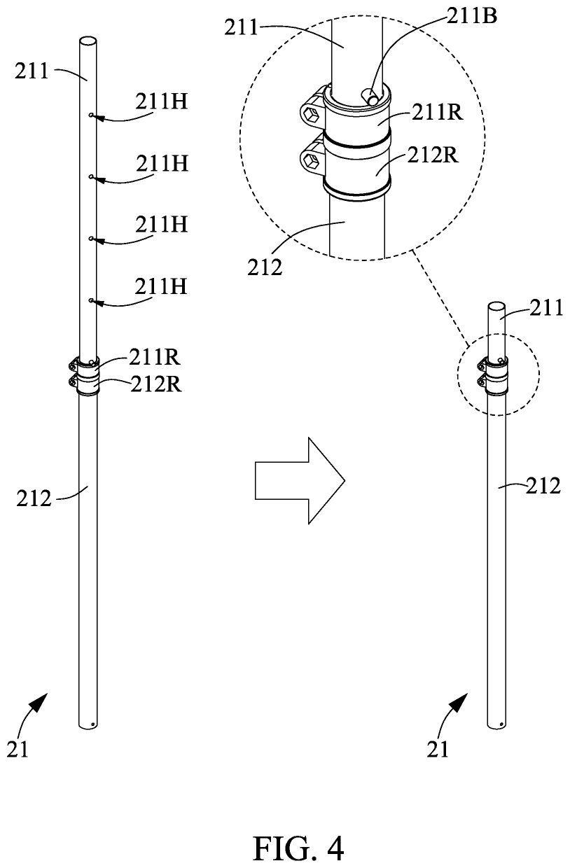

Referring to FIG. 3 and FIG. 4, FIG. 4 illustrates a schematic view of an upper support member 211 sleeved into a lower support tube 212 of the present invention. The support member 21 is disposed beyond the support surface 9 via the tripod 8 and includes the upper support member 211 and the lower support tube 212, wherein a bottom end of the upper support member 211 is sleeved into the lower support tube 212, in order to adjust a whole height of the support member 21. In detail, the upper support member 211 has a plurality of pin holes 211H from top to bottom. Hence, through the upper clamp ring 211R, a pin 211B and those pin holes 211H with different heights, the depths of the upper support member 211 inserting into the lower support tube 212 are adjusted. For the embodiment, the upper support member 211 is a hollow cylinder or solid cylinder.

Additionally, the lower clamp ring 212R firmly disposed on the lower support tube 212 is to enhance the ability of the upper clamp ring 211R supporting the pin 211B. According to FIG. 4, the upper clamp ring 211R and the lower clamp ring 212R are fixed on the upper support member 211 and the lower support tube 212 via screws and nuts (not shown in figure) individually. Further, the upper clamp ring 211R and the lower clamp ring 212R are similar to the PIPE SUPPORTS of No. KBND25A of MISUMI TAIWAN CORP.

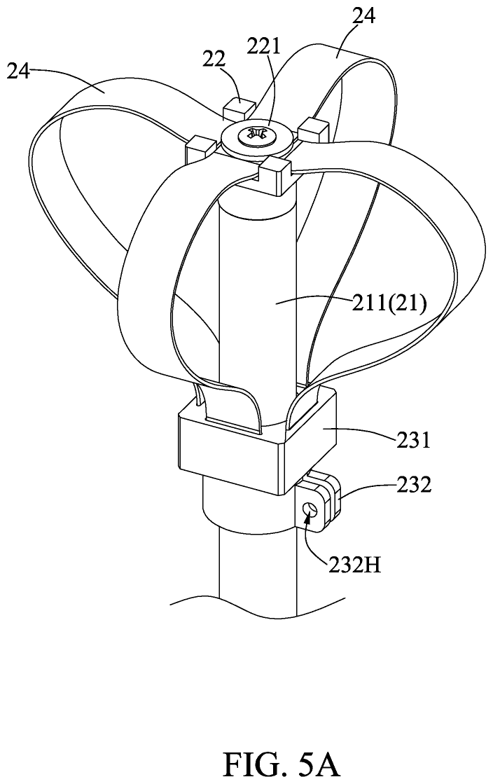

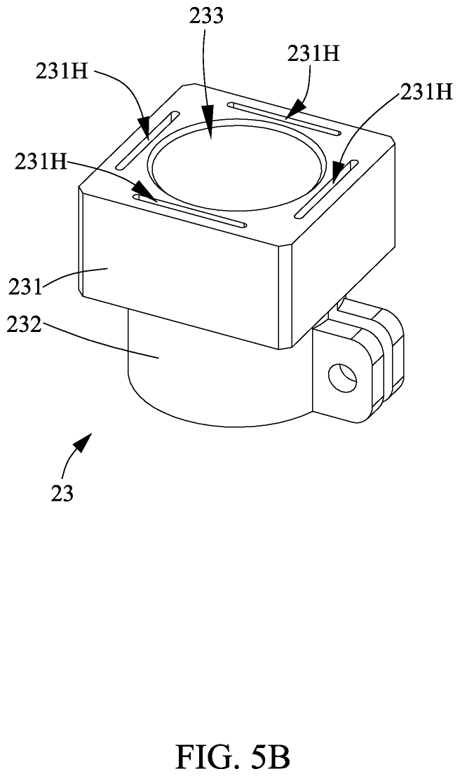

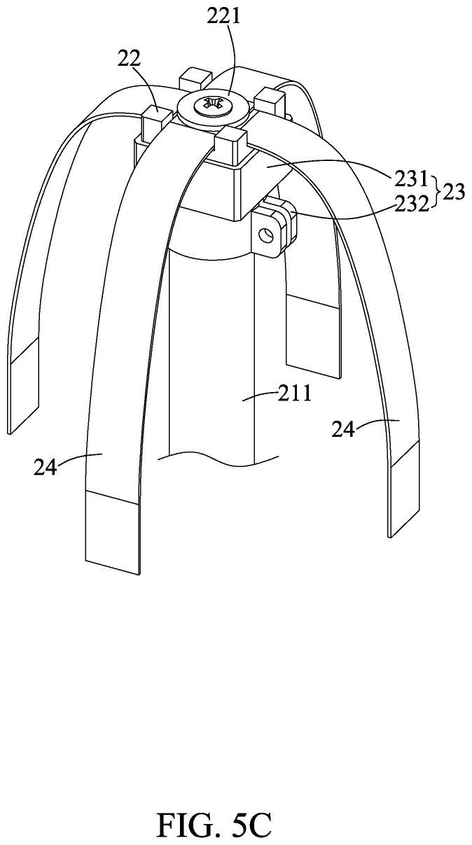

With reference to FIG. 2 and FIG. 5A to FIG. 5C, FIG. 5A illustrates a schematic view of the top block 22, the upper support member 211, the first moving block 23, the two first flexible bands 24 of the present invention, FIG. 5B illustrates a schematic view of the first moving block 23 of the present invention, and FIG. 5C illustrates a schematic view of one end of each of the two first flexible bands 24 departing from the first moving block 23 of the present invention. The top block 22 is disposed on a top end of the upper support member 211. The first moving block 23 is located below the top block 22. The first moving block 23 has a first connecting portion 231, a first clamp ring 232 and a first through hole 233. The upper support member 211 penetrates through the first through hole 233. Further, as shown in FIG. 5B, an upper surface of the first connecting portion 231 has four slim holes 231H that are averagely distributed around the four edges of the upper surface.

Further, as shown in FIG. 5A, the first clamp ring 232 has a screw hole 232H. Therefore, the first clamp ring 232 is fixed by way of a screw going through the screw hole 232H and a nut, so as to let the first moving block 23 be firmly positioned on the upper support member 211. As aforesaid, user is able to move the first moving block 23 to a desired position after the upper support member 211 goes through the first through hole 233, the first clamp ring 232 is then locked on the upper support member 211.

In a preferred embodiment, the two first flexible bands 24 are overlapped to each other. Two central portions of the two first flexible bands 24 are positioned on the top block 22 via a fastener 221, and the two ends of the first flexible band 24 are detachably connected with the first connecting portion 231 of the first moving blocks 23. Practically, the two ends of the first flexible band 24 are embedded into either up and down or left and right slim holes 231H. Accordingly, when the two ends of the first flexible band 24 are connected with the first connecting portion 231, the two ends are set at two sides of the first through hole 233. Such that, the two first flexible bands 24 are able to support helmet or hat in an arc shape.

With reference to FIG. 5C, the two ends of the first flexible band 24 are unloaded from the slim holes 231H, the top block 22 is aligned with the first connecting portion 231 since the upper support member 211 goes down, therefore the whole volume of the support frame 20 is smaller.

Since the first clamp ring 232 can be disposed at different positions on the upper support member 211, it makes the degree of the curvature of the first flexible band 24 be adjustable, so as to let the two first flexible bands 24 be formed as hollow spheres with different dimensions, which is suitable for helmet or hat with multiple sizes. Practically, adjusting the two first flexible bands 24 makes the shape of a hollow sphere be fit with an inner surface of a supported thing such as helmet or hat for stable support. In other words, to damage helmet or hat lining due to shaking can be avoided, and helmet or hat is not easily fallen down from the support frame 20. Besides, the hollow sphere benefits ventilation in helmet or hat.

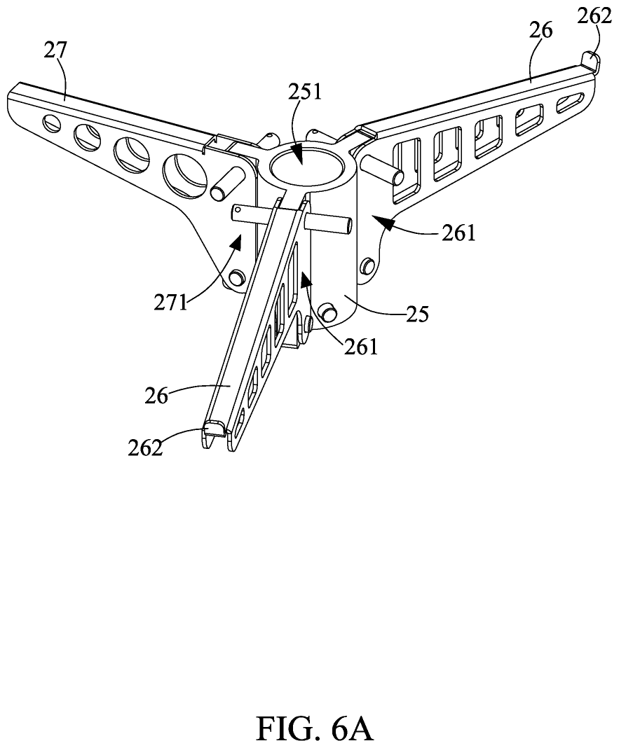

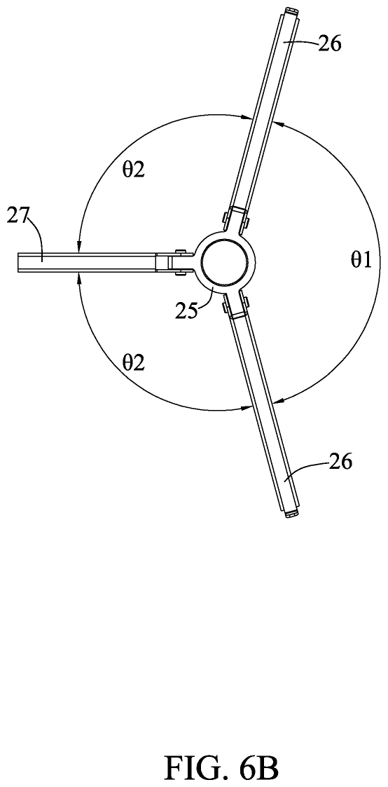

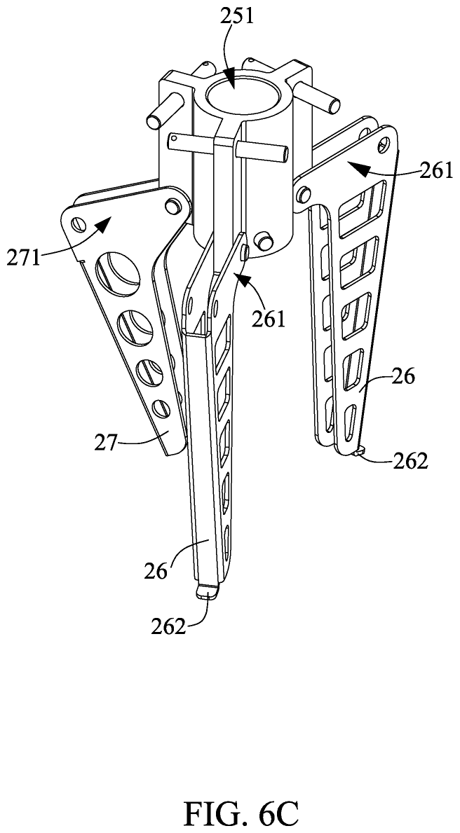

With reference to FIG. 2 and FIG. 6A to FIG. 6C, FIG. 6A illustrates a schematic 3-D view of the second moving block 25, the two first support arms 26 and the second support arm 27 of the present invention, FIG. 6B illustrates a schematic top view of the second moving block 25, the two first support arms 26 and the second support arm 27 of the present invention, and FIG. 6C illustrates a schematic view of the two first support arms 26 and the second support arm 27 in a folding state of the present invention. The second moving block 25 has a second through hole 251, and the upper support member 211 is through the second through hole 251, as shown in FIG. 2. To clearly show up the connection relationships among the second moving block 25, the two first support arms 26 and the second support arm 27, the upper support member 211 is not appeared in FIG. 6A, FIG. 6B and FIG. 6C.

Each of the two first support arm 26 includes a first assembly area 261. One end of the first support arm 26 is pivotally connected with the second moving block 25, and another end of the first assembly area 261 is firmly positioned into the second moving block 25 in a way of pin. Hence, the two first support arms 26 are capable of hanging a tactical vest or jacket. For the embodiment, an upper surface of the first support arm 26 is inclined toward the support surface 9, as shown in FIG. 3. Therefore, such arrangement facilitates deployment of tactical vests that are already mounted on them. Besides, the first support arm 26 further has a hook 262, which is located at an end of the upper surface of the first support arm 26. As it can be seen, the tactical vest is not easily slipped off the first support arm 26.

Referring to FIG. 6C again, pulling out the pins used in the two first assembly areas 261 is to let the first support arms 26 hang down naturally. Hence, it is beneficial to make the whole volume of the support frame 20 be smaller.

With respect to FIG. 6B again, an angle θ1 between the two first support arms 26 is obtuse, and the angle θ1 is 150° for the embodiment. That is, the two first support arms 26 are shaped as that of the two arms opening toward a front direction. It creates a convenience of the support member 21 not passing through the neckline of the tactical vest when the tactical vest hangs on the two first support arms 26. Such arrangement is to reserve a space to accommodate bulletproof panels in the tactical vest, wherein the space is between the tactical vest and the support member 21. Another important issue, the design of the support member 21 opening forwardly facilitates that the tactical vest is quickly accessed and hung up.

The second support arm 27 includes a second assembly area 271, and one end of the second assembly area 271 is pivotally connected with the second moving block 25, another end of the second assembly area 271 being firmly positioned into the second moving block 25 in a way of pin. Therefore, the second support arm 27 offers the function to hang up a tactical vest or belt. For an embodiment, an upper surface of the second support arm 27 is a plane parallel to the support surface 9, so as to let the tactical vest or belt not fall down very easily.

Pulling out the pin used in the second assembly areas 271 is to let the second support arms 27 hang down naturally. Hence, pulling out the pin is beneficial to fold up the support frame 20. An angle θ2 between the second support arm 27 and the adjacent first support arm 26 is obtuse, and the angle θ2 is 105° for the embodiment. Hence, the second support arm 27 is behind the two first support arm 26. It is to be noted that the second support arm 27 is not an obstruction for hanging up the tactical vest to the two first support arm 26.

As aforesaid, the first support arms 26 and the second support 27 are a design of hollow. In practice, lateral surfaces of the first support arms 26 and the second support 27 have a plurality of through holes with multiple dimensions. Accordingly, the weight of the support frame 20 and the material cost are both reduced.

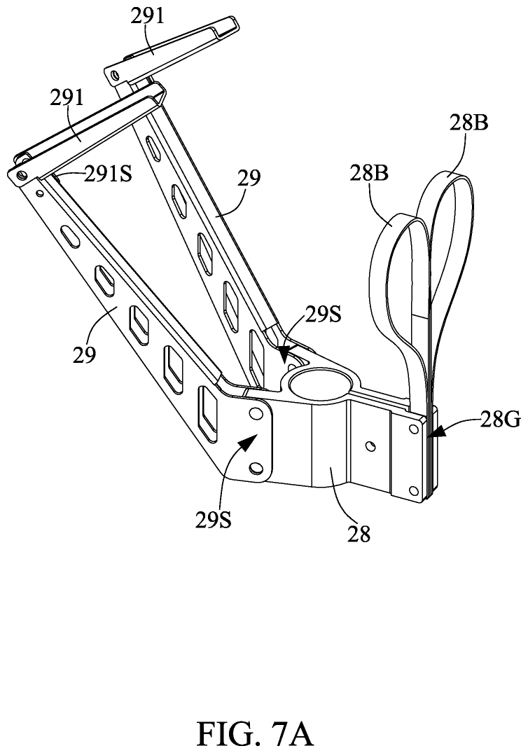

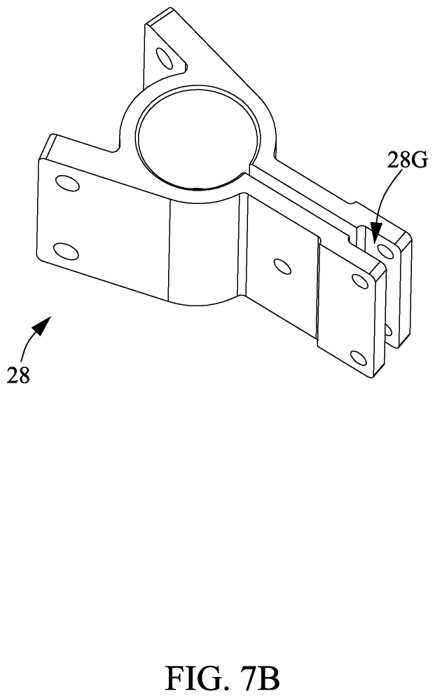

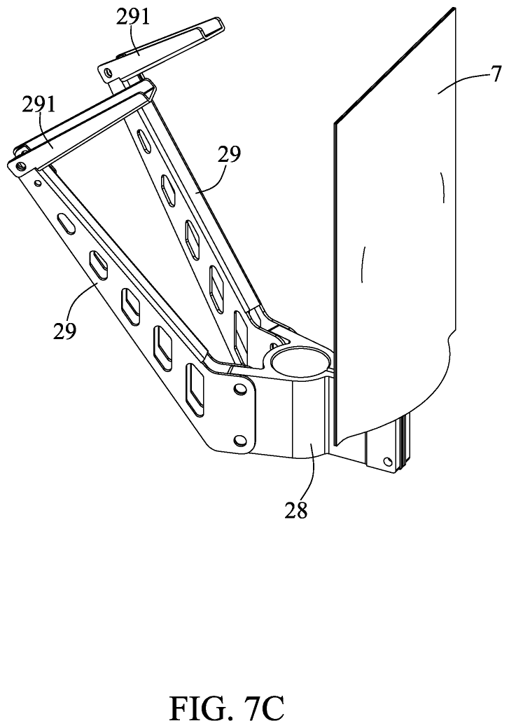

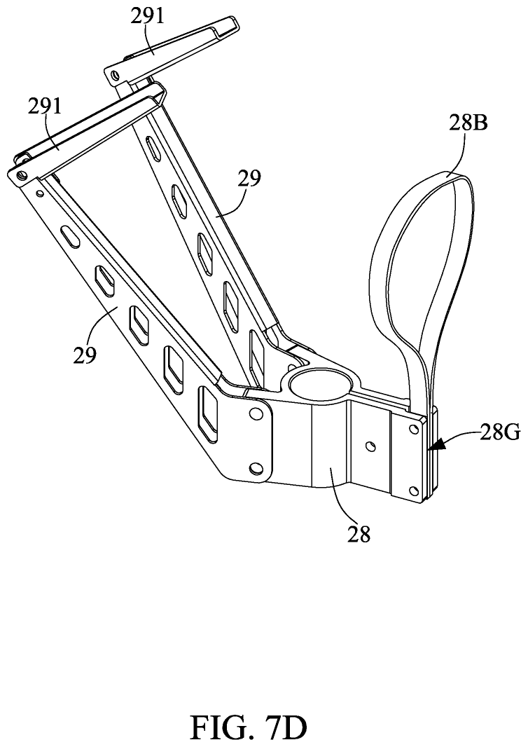

Regarding to FIG. 2 and FIG. 7A to FIG. 7C, FIG. 7A illustrates a schematic 3-D view of the second clamp ring 28, the two third support arms 29, the two auxiliary arms 291 of the present invention, FIG. 7B illustrates a schematic 3-D view of the second clamp ring 28 of the present invention, and FIG. 7C illustrates a schematic view of a water bag 7 sleeved into the two second flexible bands 28B of the present invention. The second clamp ring 28 is firmly positioned on the lower support tube 212 by means of screws and nuts and further has a rectangular slot 28G. For the embodiment, two ends of the second flexible band 28B are firmly embedded into the rectangular slot 28G. Speaking in detail, the two ends of the second flexible band 28B are embedded into the rectangular slot 28G. Then, two screws and nuts (not shown in figure) go through a lateral surface of the rectangular slot 28G and the second flexible band 28B in the rectangular slot 28G simultaneously. Accordingly, the second flexible band 28B is firmly fixed on the second clamp ring 28.

Based on FIG. 7A and FIG. 7C, once the four ends of the two second flexible bands 28B are firmly and correspondingly fastened on the rectangular slot 28G, the two second flexible bands 28B that fit side by side are shaped as a heart. Thus, the two second flexible bands 28B may hold and open the water bag 7 because of an elastic force when the two second flexible bands 28B are sleeved into the water bag 7, so as not to let inner surfaces in the water bag 7 be adhered together for blocking ventilations. Further, the water bag 7 is vertically disposed, and it is conducive to drainage and prevents foreign objects from invading into the water bag 7. In addition, as shown in FIG. 7D, only one the second flexible band 28B is embedded into the rectangular slot 28G, so as to satisfy that of holding and opening the water bag 7.

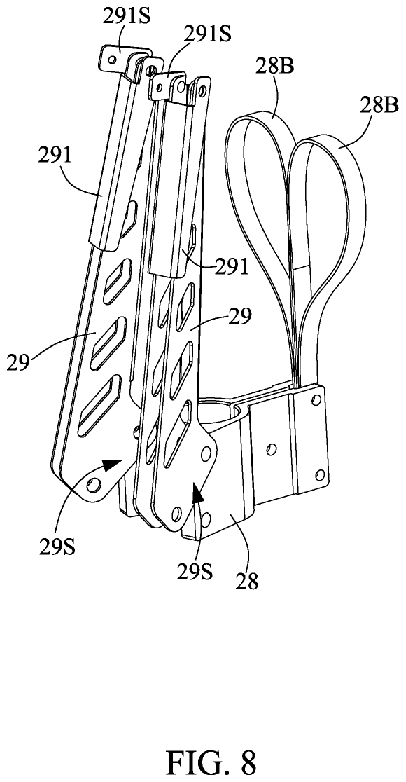

In regarding to FIG. 7A and FIG. 8, FIG. 8 illustrates a schematic view of folding the two third support arms 29 and the two auxiliary arms 291 of the present invention. The third support arm 29 includes a third assembly area 29S. One end of the third assembly area 29S is pivotally connected with the second clamp ring 28, another end of the third assembly area 29S is firmly disposed into the second clamp ring 28 in a way of pin. As it can be seen, the third support arm 29 is inclined upward and applied to hang tactical boots or a variety of footwear. Further, the inclined upward third support arm 29 offers the functions to dry tactical boots and avoid sands, debris or snakes. For the embodiment, when the end of the third assembly area 29S is not firmly disposed into the second clamp ring 28, the third support arm 29 is folded upward to be close to the second flexible band 28B.

In addition, each of the two auxiliary arms 291 is corresponding to the third support arm 29 and has a fourth assembly area 291S, wherein one end of the fourth assembly area 291S is pivotally connected with the corresponding third support arm 29, and another end of the fourth assembly area 291S is firmly disposed into the corresponding third support arm 29 in a way of pin. The arrangement relationship between the auxiliary arm 291 and the third support arm 29 is an “L” type. In such a way, The auxiliary arm 291 can support the insole inside the tactical boot and help to prevent the tactical boot from falling off the third support arm 29. As shown in FIG. 8, when the end of the fourth assembly area 291S is not firmly disposed into the third support arm 29, the auxiliary arm 291 is folded to be close to the third support arm 29, so as to make the folding volume of the support frame 20 be smaller.

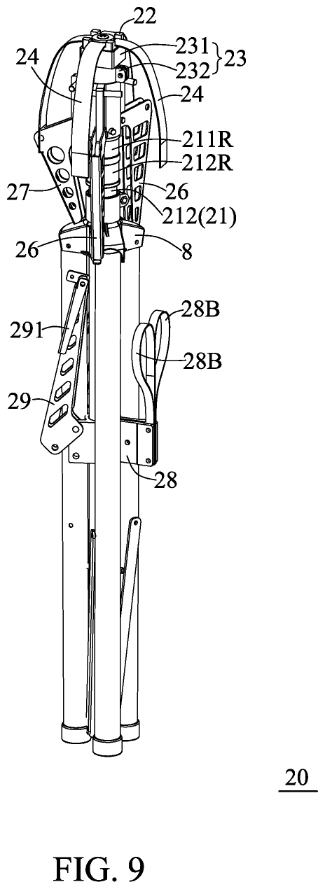

With reference to FIG. 9, which illustrates a schematic view of folding the support frame 20 of the present invention. According to FIG. 4, FIG. 5C, FIG. 6C, and FIG. 8, the different assembly members of the support frame 20 of the present invention are able to quickly be folded, so as to quickly make the volume of the support frame 20 be smaller.

As a conclusion, the support frame 20 of the present invention is capable of avoiding the damage of lining in helmet or hat and securely supporting helmet or hat. Therefore, helmet or hat is not fell down easily from the support frame 20. Additionally, the support frame 20 approaches the target of user-friendly storage.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A support frame (20) disposed on a support surface (9) comprising:
a support member (21) disposed on the support surface (9);
a top block (22) disposed on a top end of the support member (21);
a first moving block (23) having a first through hole (233), the support member (21) penetrating through the first through hole (233); and
two first flexible bands (24), overlapped to each other, two central portions of the two first flexible bands (24) being positioned on the top block (22), two ends of each of the two first flexible bands (24) being connected with the first moving block (23) and set on two sides of the first through hole (233).

2. The support frame (20) according to claim 1 further comprising:
a second moving block (25), having a second through hole (251), the support member (21) penetrating through the second through hole (251); and
two first support arms (26), each of the two first support arms (26) having a first assembly area (261), one end of the first support arm (26) being pivotally connected with the second moving block (25), an angle between the two first support arms (26) being obtuse.

3. The support frame (20) according to claim 2, wherein another end of the first assembly area (261) is firmly positioned into the second through hole (251) in a way of pin, an upper surface of the first support arm (26) being inclined toward the support surface 9.

4. The support frame (20) according to claim 2 further comprising a second support arm (27) with a second assembly area (271), one end of the second assembly area (271) being pivotally connected with the second moving block (25), another end of the second assembly area (271) being firmly positioned into the second moving block (25) in a way of pin, an angle between the second support arm (27) and the first support arm (26) being obtuse, wherein the second support arm (27) and the first support arm (26) are adjacent to each other.

5. The support frame (20) according to claim 2, wherein the first moving block (23) has a first connecting portion (231) and a first clamp ring (232), the two ends of the first flexible band (24) being connected with the first connecting portion (231), the first clamp ring (232) being disposed on the support member (21).

6. The support frame (20) according to claim 2, the two ends of the first flexible band (24) are detachably connected with the first moving blocks (23).

7. The support frame (20) according to claim 2, wherein the support member (21) has an upper support member (211) and a lower support tube (212), a bottom end of the upper support member (211) being sleeved into the lower support tube (212), the upper support member (211) being penetrated through the first through hole (233) and the second through hole (251).

8. The support frame (20) according to claim 7 further comprising:
a second clamp ring (28), firmly disposed on the lower support tube (212); and
two third support arms (29), each of the two third support arms (29) having a third assembly area (29S), one end of the third assembly area (29S) being pivotally connected with the second clamp ring (28), another end of the third assembly area (29S) being firmly disposed into the second clamp ring (28) in a way of pin.

9. The support frame (20) according to claim 8 further comprising:
two auxiliary arms (291), each of the two auxiliary arms (291) being corresponding to the third support arm (29) and having a fourth assembly area (291S);
wherein one end of the fourth assembly area (291S) is pivotally connected with the corresponded third support arm (29), and another end of the fourth assembly area (291S) is firmly disposed into the corresponded third support arm (29) in a way of pin.

10. The support frame (20) according to claim 8 further comprising:
at least one second flexible band (28B), the second clamp ring (28) further having a rectangular slot (28G);
wherein two ends of the second flexible band (28B) are firmly embedded into the rectangular slot (28G).

11. The support frame (20) according to claim 1, wherein the first moving block (23) has a first connecting portion (231) and a first clamp ring (232), the two ends of the first flexible band (24) being connected with the first connecting portion (231), the first clamp ring (232) being disposed on the support member (21).

12. The support frame (20) according to claim 1, the two ends of the first flexible band (24) are detachably connected with the first moving blocks (23).

13. The support frame (20) according to claim 1, wherein the support member (21) has an upper support member (211) and a lower support tube (212), a bottom end of the upper support member (211) being sleeved into the lower support tube (212), the upper support member (211) being penetrated through the first through hole (233) and the second through hole (251).

14. The support frame (20) according to claim 13 further comprising:
a second clamp ring (28), firmly disposed on the lower support tube (212); and
two third support arms (29), each of the two third support arms (29) having a third assembly area (29S), one end of the third assembly area (29S) being pivotally connected with the second clamp ring (28), another end of the third assembly area (29S) being firmly disposed into the second clamp ring (28) in a way of pin.

15. The support frame (20) according to claim 14 further comprising:
two auxiliary arms (291), each of the two auxiliary arms (291) being corresponding to the third support arm (29) and having a fourth assembly area (291S);
wherein one end of the fourth assembly area (291S) is pivotally connected with the corresponded third support arm (29), and another end of the fourth assembly area (291S) is firmly disposed into the corresponded third support arm (29) in a way of pin.

16. The support frame (20) according to claim 14 further comprising:
at least one second flexible band (28B), the second clamp ring (28) further having a rectangular slot (28G);
wherein two ends of the second flexible band (28B) are firmly embedded into the rectangular slot (28G).
